(19) United States
(12) Patent Application Publication
(10) Pub. No.: US 2005/0062999 A1
(43) Pub. Date: Mar. 24, 2005

(54) Image processing apparatus and control method of the same

(75) Inventor: Seiya Fujinaga, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/944,702

(22) Filed: Sep. 21, 2004

(30) Foreign Application Priority Data
Sep. 24, 2003 (JP) 2003-332507

(51) Int. Cl. G06F 3/12

(52) U.S. Cl. 358/1.14

(57) ABSTRACT

To provide a control method of an image processing apparatus capable of showing a user that a printing designation by the user exceeds the tolerance of an image processing apparatus before printing and therefore, capable of preventing unnecessary printing. When the printing designation performed by the user clearly deviates from the tolerance of the processor, it is an object of the present invention to provide an image processing apparatus for confirming whether to execute printing to the user even if the printing designation exceeds the tolerance before starting the printing, and a control method of the image processing apparatus.

### BACKGROUND OF THE INVENTION

1. Field of the Invention

The present invention relates to an image processing apparatus and a control method of the image processing apparatus.

2. Related Background Art

A digital camera has been suddenly spread in recent years. The recognition that the digital camera is a peripheral device of a personal computer has been strong. However, the digital camera is used for a home having no personal computer and thus, the sales of digital cameras have been increased. Therefore, the demand for directly printing digital camera data by a domestic-use printer not through a personal computer has been raised particularly in recent years.

The data photographed by a digital camera is stored in a memory card such as SD card or compact flash (registered trademark) memory. When a personal computer is present in a home, it is possible to capture image data into the personal computer and print the data by a recorder such as a printer.

A user having no personal computer uses a method for printing a photo in accordance with an operation performed through an operation section of a recorder by directly inserting a medium for storing a digital image such as a memory card into the recorder as a direct printing method not through personal computer. Therefore, the requests for photo printing in homes is increased and the demand for printing in homes is increased.

As described above, because the demand for printing in homes is increased, the demand for printing is increased also for low-end complex machines and printers. Therefore, the number of prints of digital images by a complex machine or printer is increased and the ink consumption by users is being increased. Particularly, because the capacity of a memory card increases, it is possible to store a lot of images of digital cameras. Therefore, the demand for printing many images at the same time is raised.

However, in the case of a machine such as domestic-use low end, because an ink quantity is small, it is impossible to execute much printing as expected. Particularly, when executing much printing at the same time, printing in which the tolerance of ink of the printer is already exceeded may be designated. In this case, there is a problem that it is difficult to correctly execute printing to the end. To solve the problem, the following method has been used so far.

For example, one method is known in which when setting a restriction to the number of sheets to be printed by a printer and executing printing by exceeding the restriction, printing is stopped (for example, refer to Japanese Patent Application Laid-open No. 2000-272207).

Moreover, another method is known in which when running-out of ink is detected while printing is executed by a printer, the job is cancelled at this point of time, it is determined whether to start output again or erase data from a memory and printing is executed after replacing ink when subsequent printing is necessary (for example, refer to Japanese Patent Application Laid-open No. H09-069920).

However, the above conventional method is a method for executing printing and stopping the printing during the printing. Therefore, this method has a problem that because printing is executed while the printing quantity designated by a user is unknown at the start of printing, it is impossible to know whether the printing quantity is proper until the printing is completed.

Moreover, another conventional method is known in which a restricted number of printed sheets is set every user of a printer and printing can be made within the restriction (refer to Japanese Patent Application Laid-open No.H11-095937). However, in the case of this conventional example, the restricted number of sheets is only set every user but it is not related to the allowable number of printed sheets of the whole printer.

Therefore, when a user executes the printing designation in which the number of printed sheets is not clear, it is necessary that the user can execute printing within the tolerance of a printer by communicating the number of printed sheets to the user before printing is started.

In the case of the above conventional example, when a user designates printing while the number of printed sheets is unknown, there is a problem that printing is started even if the user does not know a designation clearly exceeding the tolerance of the printing quantity of an image processing apparatus.

That is, in the case of the above conventional example, there is a problem that it is impossible to show the user that the printing designation by the user exceeds the tolerance of an image processing apparatus and therefore, it is impossible to prevent unnecessary printing.

### SUMMARY OF THE INVENTION

It is an object of the present invention to provide a control method of an image processing apparatus capable of showing a user that the printing designation by the user exceeds the tolerance of an image processing apparatus before printing and thereby, preventing unnecessary printing.

### BRIEF DESCRIPTION OF THE DRAWINGS

FIG. 1 is a block diagram showing a schematic configuration of an image processing apparatus 100 constituting an image processing system which is embodiment 1 of the present invention;

FIG. 2 is an illustration showing a specific example of an operation/display unit 108 set to the image processing apparatus 100;

FIG. 3A is an illustration showing a flowchart showing a reconfirmation operation, and FIG. 3B is an illustration showing a display example of a LCD 201 when the number of printed sheets exceeds a restriction when starting printing in the above embodiment;

FIG. 4 is a flowchart showing a reconfirmation operation when printing is started and the number of printed sheets exceeds a restriction in embodiment 2 of the present invention;

FIG. 5 is a flowchart showing a reconfirmation operation when printing is started and the number of printed sheets exceeds a restricted number of printed sheets in embodiment 3 of the present invention;

FIG. 6 is a flowchart showing a reconfirmation operation when printing is started and the number of printed sheets exceeds a restricted number of printed sheets in embodiment 4 of the present invention; and

FIG. 7 is a flowchart showing an example in which number-of-printed-sheet data acquiring means calculates the number of printed sheets in each of the above embodiments.

### DESCRIPTION OF THE PREFERRED EMBODIMENTS

Best modes for embodying the present invention are the following embodiments.

### Embodiment 1

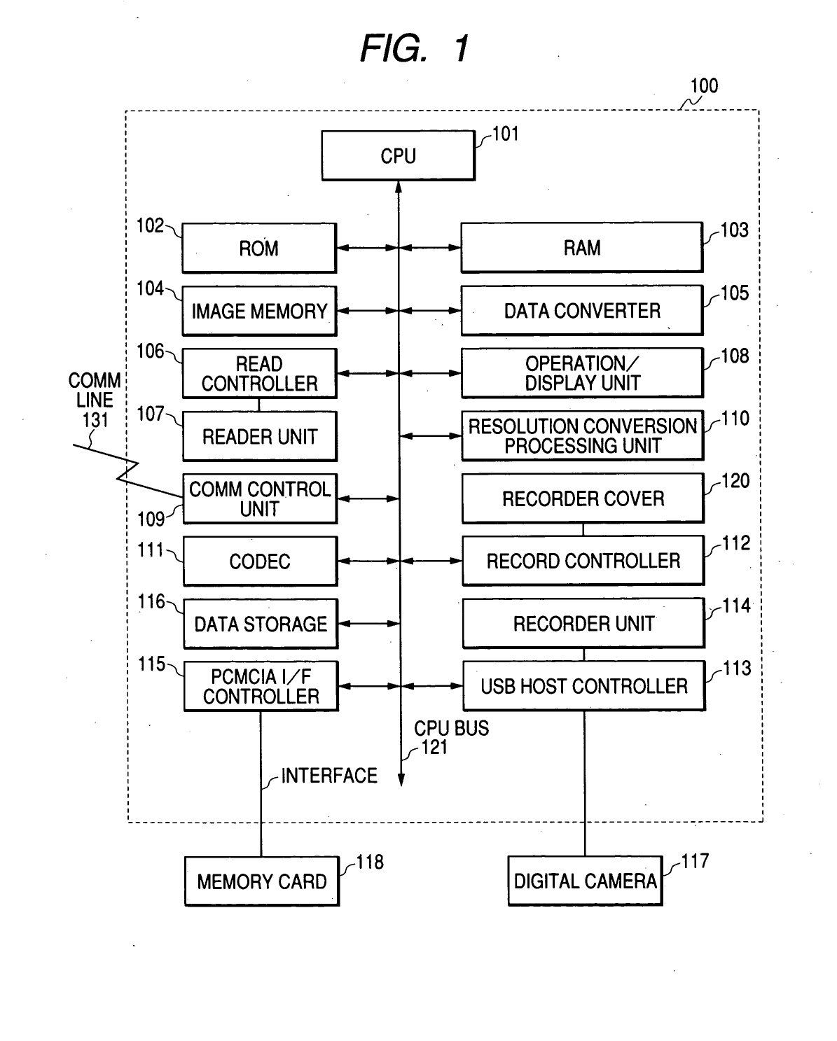

FIG. 1 is a block diagram showing a schematic configuration of the image processing apparatus 100 constituting the image processing system which is embodiment 1 of the present invention.

The image processing apparatus 100 has a CPU 101, a ROM 102, a RAM 103, an image memory 104, a data converter 105, a read controller 106, a reader unit 107, an operation/display unit 108, a communication control unit 109, a resolution conversion processing unit 110, a CODEC 111, a record controller 112, a USB host controller 113, a recorder unit 114, a PCMCIA I/F controller 115, a data storage 116, a digital camera 117, a memory card 118, a recorder cover 120 and a CPU bus 121.

The CPU 101 is a system control unit to control the whole of the image processing apparatus 100.

The ROM 102 stores a control program to be executed by the CPU 101 and a built-in operating system (OS) program. In the case of the above embodiment, each control program stored in the ROM 102 executes software control such as scheduling or task switching under the control by the built-in OS stored in the ROM 102.

The RAM 103 is constituted by an SRAM (static RAM) or the like and stores a program control variable, a setting value entried by an operator, and a management data of the image processing apparatus 100, in which various work buffer regions are formed.

The image memory 104 is constituted by a DRAM (dynamic RAM) or the like to store image data.

The data converter 105 executes conversion of image data such as analysis of a page description language (PDL) or the like and CG (computer graphics) development of character data.

The read controller 106 applies various image processings such as binalization and half-tone processing to an image signal acquired when the reader unit 107 optically reads an original by a CIS image sensor (close-contact image sensor) and converts it into electrical image data, through a not-illustrated image processing controller, and outputs high-accuracy image data. In the case of the above embodiment 1, the read controller 106 corresponds to both control systems such as a sheet read control system for executing read while carrying a manuscript and a book read control system for scanning a manuscript on a manuscript table.

The operation/display unit 108 is constituted by (1) an operation unit provided with numeral input keys, character input keys, one-touch telephone-number keys, a mode setting key, a decision key, a cancel key, in which a user performs decision of image transmitting destination data, entry of entered value setting data and setting of energy-saving mode, various keys, LED (Light Emitting Diode) and LCD (Liquid Crystal Display) and (2) a display unit for displaying various input operations by an operator and an operation state and status of the image processing apparatus 100.

The communication control unit 109 is constituted by a MODEM (modulator demodulator) and an NCU (network control unit). In the case of the above embodiment, the communication control unit 109 is connected to an analog communication line (PSTN) 131 to perform communication control with T30 protocol and line control such as an outgoing call and incoming call to a communication line.

The resolution conversion processing unit 110 executes resolution conversion control such as mille-inch resolution conversion of image data or the like. In the case of the resolution conversion processing unit 110, it is also possible to expand and contract image data.

The CODEC 111 codes and decodes or expands and contracts the image data (MH, MR, MMR, JBIG and JPEG) handled by the image processing apparatus 100.

The record controller 112 applies various image processings such as smoothing, recording density correction and color correction to image data to be printed, through a not-illustrated image processing controller, converts the image data into high-accuracy image data, and outputs the image data to the USB host controller 113 (to be described later). Moreover, by controlling the USB host controller 113, the record controller 112 regularly acquires the status information data for the recorder unit 114.

The recorder unit 114 is a printer constituted by a laser beam printer or ink-jet printer to print color image data or monochrome image data on a printing member. The recorder unit 114 communicates with the USB host controller 113 in accordance with a protocol specified in the USB communication standard and particularly has a function.

The USB host controller 113 is a controller for performing communication in accordance with a protocol specified in the USB communication standard. The USB communication standard is a standard capable of performing bidirectional data communication at a high speed, which allows a plurality of hubs or functions (slaves) to be connected with one host (master). The USB host controller 113 has a function of a host in USB communication.

The PCMCIA I/F controller 115 performs the communication control of a USB interface, performs protocol control in accordance with the USB communication standard, converts the data from a USB control task to be executed by the CPU 101 into a packet, transmits a USB packet to an external information processing terminal and converts a USB packet from an external information processing terminal into data and transmits the data to the CPU 101.

A data storage 116 is a portion in which data is stored. Because the DRAM of the image memory 104 does not prepare a data-backup region, the embodiment 1 prepares a data storage region as a data storage. Moreover, the data storage 116 may be shared with the image memory 104 and may back up data. Though the embodiment 1 uses a DRAM, it is also allowed to use a hard disk or volatile memory instead of the DRAM.

The digital camera 117 is a camera for storing an image photographed by a lens as digital data. The camera 117 can be connected with the USB host controller 113 and makes it possible to exchange data between the digital camera 117 and the image processing apparatus 100 by performing communication.

The memory card 118 is a data recording medium which can be connected to the image processing apparatus 100. In the case of the embodiment 1, the memory card 118 is connected by the interface of a PCMCIA but it is not restricted to the interface. It is also allowed to make image data or other electronic data access the data in the memory card through the PCMCIA I/F controller 115.

In the case of the embodiment 1, the USB communication of the recording function uses one-to-one connection conformation.

The above components 101 to 106 and 108 to 113 are connected each other through the CPU bus 121 controlled by the CPU 101.

The recorder unit 114 is an example of printing means for printing photos and characters.

The CPU 101 and ROM 102 are respectively an example of the number-of-printed-sheet data acquiring means for acquiring the data for the number of printed sheets before printing is started.

The RAM 103 is an example of the restricted-number-of-printed-sheets data holding means for holding the restricted-number-of-printed-sheet data showing the restricted number of printed sheets.

The operation/display unit 108 is an example of operation means for starting or setting printing.

The operation/display unit 108 is an example of display means for displaying the information on an image processing apparatus.

The CPU 101 and ROM 102 are respectively an example of display control means for making the display means perform the display for prompting a user to reconfirm start of printing when a printing designation is obtained through the operation means, the number-of-printed-sheet data acquiring means acquires the number-of-printed-sheet data and the number of printed sheets shown by the acquired number-of-printed-sheet data exceeds the restricted number of printed sheets.

In the above embodiment, an image data storing medium is constituted by the PCMCIA I/F controller 115 and memory card 118. The memory card 118 is an example of an external storing medium.

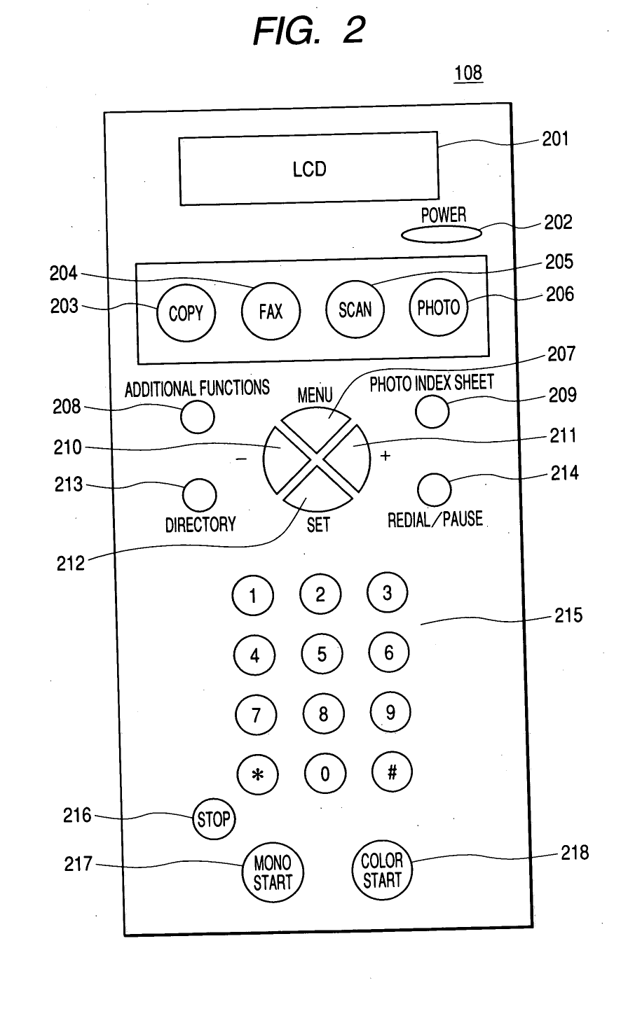

FIG. 2 is an illustration showing a specific example of the operation/display unit 108 set to the image processing apparatus 100.

The operation/display unit 108 has an LCD 201, a power supply key 202, a copy mode key 203, a fax mode key 204, a scan mode key 205, a photo mode key 206, a menu key 207, a user setting key 208, a photo index sheet key 209, a minus key 210, a plus key 211, a setting key 212, a telephone book key 213, a redialing key 214, a ten key 215, a stop key 216, a monochrome start key 217 and a color start key 218.

The LCD display 201 is a display for displaying a message, operation prompt and various informations.

The power supply key 202 is a key for turning on/off the power supply of the image processing apparatus.

The copy mode key 203 is a key for bringing the image processing apparatus 100 into a state ready for copying. By pressing the copy mode key 203, the image processing apparatus 100 is brought into a copy mode.

The fax mode key 204 is a key for brining the image processing apparatus 100 into a state ready for faxing. By pressing the fax mode key 204, the image processing apparatus 100 is brought into a fax mode.

The scan mode key 205 is a key for brining the image processing apparatus 100 into a state ready for scanning. By pressing the scan mode key 205, the image processing apparatus 100 is brought into a scan mode.

The photo mode key 206 is a key for bringing the image processing apparatus 100 into a state ready for direct printing from a digital photo card or camera. By pressing the photo mode key 206, it is possible to bring the image processing apparatus 100 into a photo mode.

The menu key 207 is a key for displaying an item for setting a set-value when direct printing from a copy, fax or card or is executed. By pressing the menu key 207, it is possible to display a setting item for execution on the LCD 201 and set the item by selecting the item with a the plus key 211 or minus key 210 and setting the item with the setting key 212.

The user setting key 208 is a key for displaying a screen for a user to enter a set value to be set to the image processing apparatus 100. By pressing the user setting key 208, it is possible to display user setting items on the LCD 201 and set the item with setting key 212 by selecting the item with the plus key 211 or minus key 210.

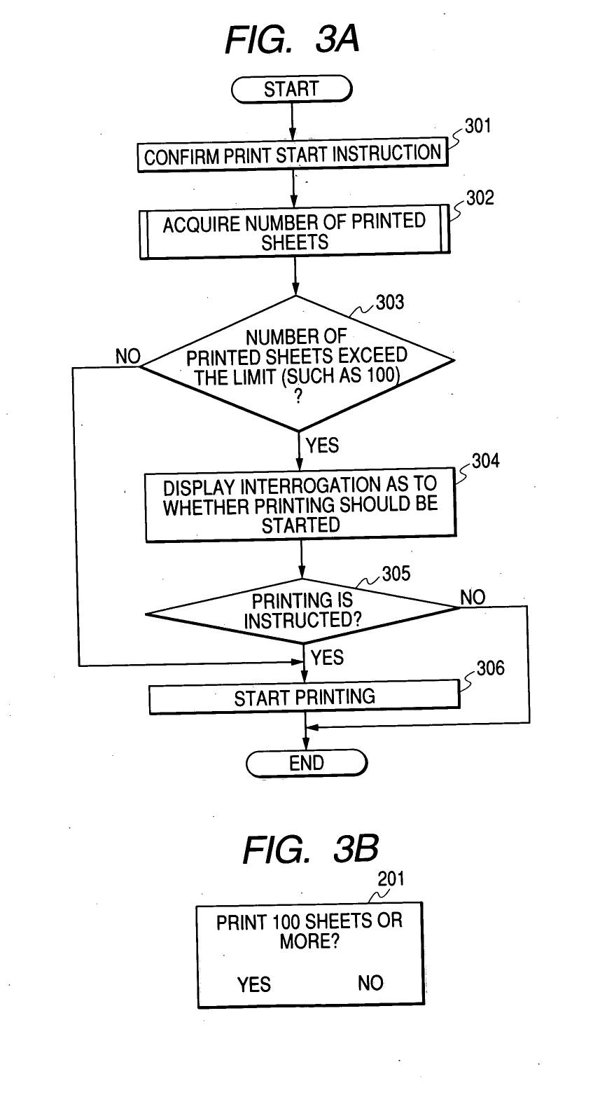

The photo index sheet key 209 is a key for changing the present screen to a screen for printing or reading a photo index sheet. By pressing the photo index sheet key 209 while the memory card 118 is inserted into the image processing apparatus 100, the present screen is changed to a screen for designating printing or reading of the photo index sheet. It is possible to select reading or printing with the plus key 211 or minus key 210 and set reading or printing through the setting key 212. The photo index sheet is described in the description for FIGS. 3A and 3B in detail.

The minus key 210 and plus key 211 are keys used for a user to select a menu or user entry from a plurality of options. Minus and plus are reverse order or normal order.

The setting key 212 is a key for deciding a selected item. The telephone book key 213 is a key for calling a telephone number entered in a telephone book. The redialing key 214 is a key for redialing the lastly dialed destination party by pressing it.

The ten key 215 is a key group used for entry of a telephone number, facsimile number or destination party name, the number of copies and dialing. The stop key 216 is a key for stopping facsimile transmission/reception, copying or other operation.

The monochrome start key 217 is a key for starting monochrome facsimile transmission or monochrome copying. The color start key 218 is a key for starting color facsimile transmission, color copying or color photo printing.

FIG. 3A is a flowchart showing the reconfirmation operation when printing is started and the number of printed sheets exceeds a restriction in the above embodiment, and FIG. 3B is an illustration showing a display example of the LCD 201.

FIG. 3A is a flowchart showing the reconfirmation operation when the number of printed sheets exceeds a restriction when starting printing in the above embodiment.

First, in step 301, it is recognized that start of printing is designated by a user. In step S302, the number of printed sheets is acquired for the printing designation. Particularly, operations of the number-of-printed-sheet data acquiring means when the printing in this case is the printing of a plurality of image data values will be described later.

Then, in step 303, the acquired number of printed sheets is compared with the restricted number of printed sheets (e.g. 100 printed sheets). If the acquired number of printed sheets exceeds the restricted number of printed sheets in step 302, step 304 is started.

In step 303, when the number of printed sheets does not exceed the restricted number of printed sheets, step 306 is started. In step,304, whether to actually start printing is displayed on the LCD 201 of the operation/display unit 108.

FIG. 3B is an illustration showing an example of the display for inquiring a user whether to start printing (display for prompting the user to reconfirm start of printing) in step 304.

In this case, the number of printed sheets acquired in step 302 is displayed on the operation/display unit 108. Then, in step 305, a designation whether to start printing performed by a user through the operation/display unit 108 is waited in accordance with the prompt in step 304 (display for prompting the user to reconfirm start of printing). When the user designates start of printing, step 306 is started to execute printing. However, when the user does not designate start of printing, the operation is completed without executing printing.

Therefore, according to the embodiment 1, it is possible to reconfirm start of printing to a user in accordance with the number of printed sheets.

That is, the embodiment 1 is an image processing apparatus having printing means for printing photos and characters, number-of-printed-sheet data acquiring means for acquiring the number-of-printed-sheet data showing the number of printed sheets before printing is started, restricted-number-of-printed-sheet data holding means for holding the restricted-number-of-printed-sheet data showing the restricted number of printed sheets, operation means for starting or setting printing, display means for displaying the information on the image processing apparatus and display control means for making the display means perform the display for prompting a user to reconfirm start of printing when the number-of-printed-sheet data acquiring means acquires the data for the number of printed sheets when printing is designated through the operation means and the number of printed sheets shown by the acquired-number-of-printed-sheet data exceeds the restricted number of printed sheets.

### Embodiment 2

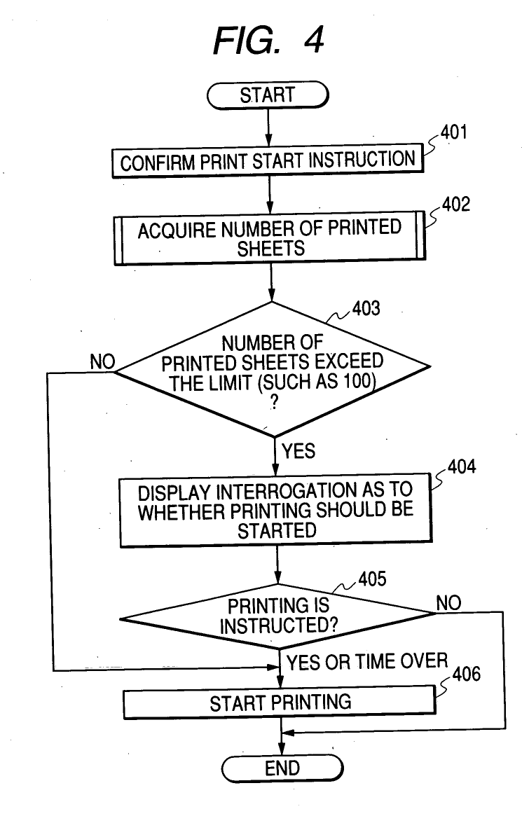

FIG. 4 is a flowchart showing the reconfirmation operation when the number of printed sheets exceeds a restriction while starting the printing which is embodiment 2 of the present invention.

The embodiment 2 is an embodiment for starting printing when a time-out occurs while confirmation of restart of printing is requested for a user.

First, in step 401, it is recognized that a user designates start of printing. In step 402, the number of printed sheets is acquired for the printing designation. Particularly, the operation to be performed by the number-of-printed-sheet-data acquiring means when the printing in this case is the printing of a plurality of image data will be described later.

Then, in step 403, the acquired number of printed sheets is compared with a restricted number of printed sheets (e.g. 100 printed sheets). If the acquired number of printed sheets exceeds the restricted number of printed sheets in step 402, step 404 is started.

Moreover, when the number of printed sheets does not exceed the restricted number of printed sheets in step 403, step 406 is started. In step 404, whether to actually start printing is displayed on the operation/display unit 108. In this case, the number of printed sheets acquired in step 402 is displayed on the operation/display unit 108 and step 405 is started.

In step 405, a designation whether to start printing by a user in the operation/display unit 108 is waited in accordance with the display for inquiring the user about whether to start printing in step 404 (display for prompting the user to reconfirm start of printing) in step 404. If the user designates start of printing, step 406 is started to execute printing.

However, when a timeout occurs in step 405, the present step is changed to step 406. Moreover, when the user does not designate printing, printing is not executed but the operation is terminated.

According to the embodiment 2, it is possible to reconfirm start of printing to a user in accordance with the number of printed sheets. However, even if the user does not notice the display, printing is correctly executed.

That is, the embodiment 2 is an image processing apparatus having printing means for printing photos and characters, number-of-printed-sheet-data acquiring means for acquiring the number-of-printed-sheet data showing the number of printed sheets before printing is started, restricted-number-of-printed-sheet-data holding means for holding the data for the restricted number of printed sheets showing the restricted number of printed sheets, operation means for starting or setting printing, display means for displaying the information on an image processing apparatus, clocking means for measuring time and control means for making the display means to perform the display for prompting a user to reconfirm start of printing when the number of printed sheets shown by the number-of-printed-sheet data acquired by the number-of-printed-sheet data acquiring means exceeds the restricted number of printed sheets and executing a predetermined operation when a predetermined time passes while the user does not reconfirm the start of printing when printing is designated through the operation means.

### Embodiment 3

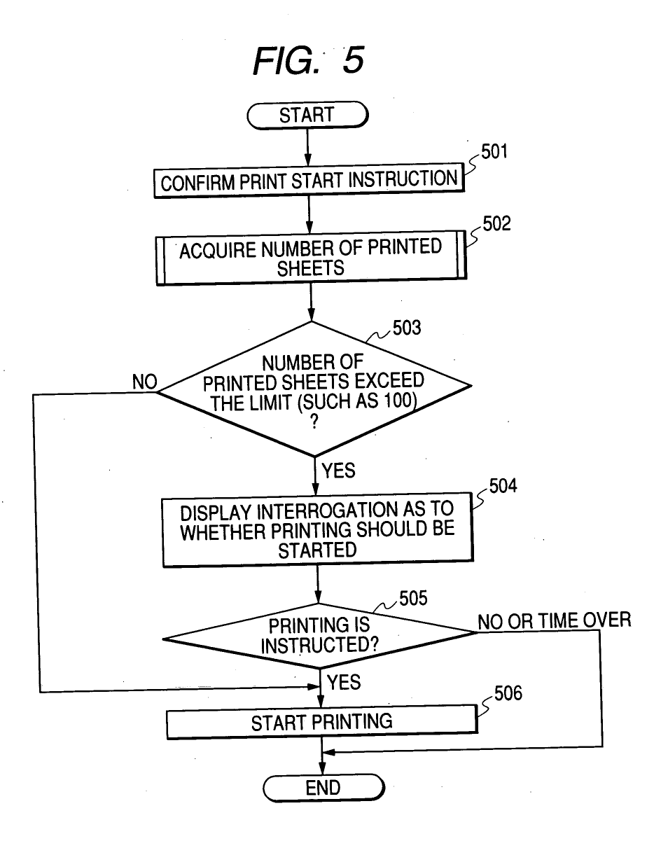

FIG. 5 is a flowchart showing the reconfirmation operation when the number of printed sheets exceeds the restricted number of printed sheets at the start of the printing which is embodiment 3 of the present invention.

The embodiment 3 is an embodiment which does not start printing if a timeout occurs when inquiring a user about restart of printing.

First, in step 501, it is recognized that the user designates start of printing. Then, in step 502, the number of printed sheets is acquired for the printing designation. Particularly, the operation to be executed by the number-of-printed-sheet-data acquiring means when the printing in this case is the printing of the data for a plurality of images will be described later.

Moreover, in step 503, the number of printed sheets acquired in step 502 is compared with the restricted number of printed sheets (e.g. 100 printed sheets). When the number of printed sheets acquired in step 502 exceeds the restricted number of printed sheets, step 504 is started.

Furthermore, when the number of printed sheets does not exceed the restricted number of printed sheets in step 503, step 506 is started. In step 504, the display for inquiring a user about whether to start printing (display for prompting a user to reconfirm start of printing) is performed.

In this case, the number of printed sheets acquired in step 502 is displayed on the operation/display unit 108. Then, in step 505, based on inquiring in step 504 the designation on whether to start printing performed by a user through the operation/display unit 108 is waited. When the user designates start of printing, step 506 is started to execute printing. However, when the user does not designate printing, printing is not executed. When a timeout occurs in step 505, the operation is terminated without executing printing.

According to the embodiment 3, it is possible to reconfirm start of printing to a user in accordance with the number of printed sheets and perform control so as not to start printing when the user does not notice the display.

That is, the embodiment 3 is an image processing apparatus having printing means for printing photos and characters, number-of-printed-sheet-data acquiring means for acquiring the number-of-printed-sheet data showing the number of printed sheets before printing is started, restricted-number-of-printed-sheet-data holding means for holding the restricted-number-of-printed-sheet data showing the restricted number of printed sheets, operation means for starting or setting printing, display means for displaying the information on the image processing apparatus, clocking means for measuring time and control means for acquiring the number-of-printed-sheet data acquired by the number-of-printed-sheet-data acquiring means when printing is designated through the operation means and not executing printing when the number of printed sheets shown by the acquired data for the number of printed sheets exceeds the restricted number of printed sheets.

### Embodiment 4

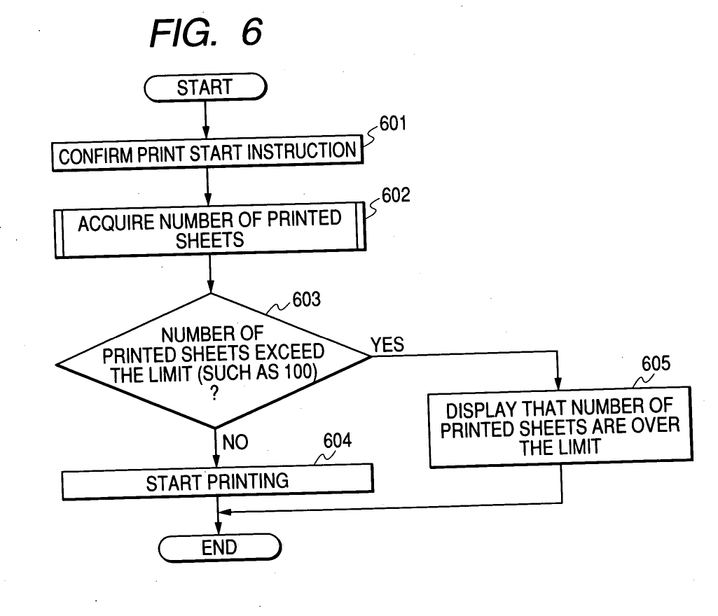

FIG. 6 is a flowchart showing the reconfirmation operation when the number of printed sheets exceeds the restricted number of printed sheets when starting the printing which is embodiment 4 of the present invention.

The embodiment 4 is an embodiment for not starting printing when a timeout occurs while prompting a user to decide whether to restart printing.

First, in step 601, it is recognized that a user designates start of printing. Then, in step 602, the number of printed sheets is acquired for the printing designation. Particularly, the operation to be performed by the number-of-printed-sheet-data acquiring means when the printing in this case is the printing of the data for a plurality of images will be described later.

Then, in step 603, the number of printed sheets acquired in step. 602 is compared with the restricted number of printed sheets (e.g. 100 printed sheets). When the number of printed sheets acquired in step 602 does not exceed the restricted number of printed sheets, step 604 is started to execute printing.

Moreover, when the number of printed sheets exceeds the restricted number of printed sheets in step 603, step 605 is started. However, because the number of printed sheets exceeds the tolerance of a printer, it is shown to the operation/display unit 108 that the number of printed sheets exceeds the tolerance of an image processing apparatus and the operation is completed without executing printing.

According to the embodiment 4, it is possible to perform control so as not to start printing when the number of printed sheets exceeds the restricted number of printed sheets correspondingly to the number of printed sheets.

In the case of the embodiment 4, the number-of-printed-sheet-data acquiring means calculates the number of printed sheets according to the number of images in a memory card. However, it is also allowed to acquire the total number of printed sheets by another method.

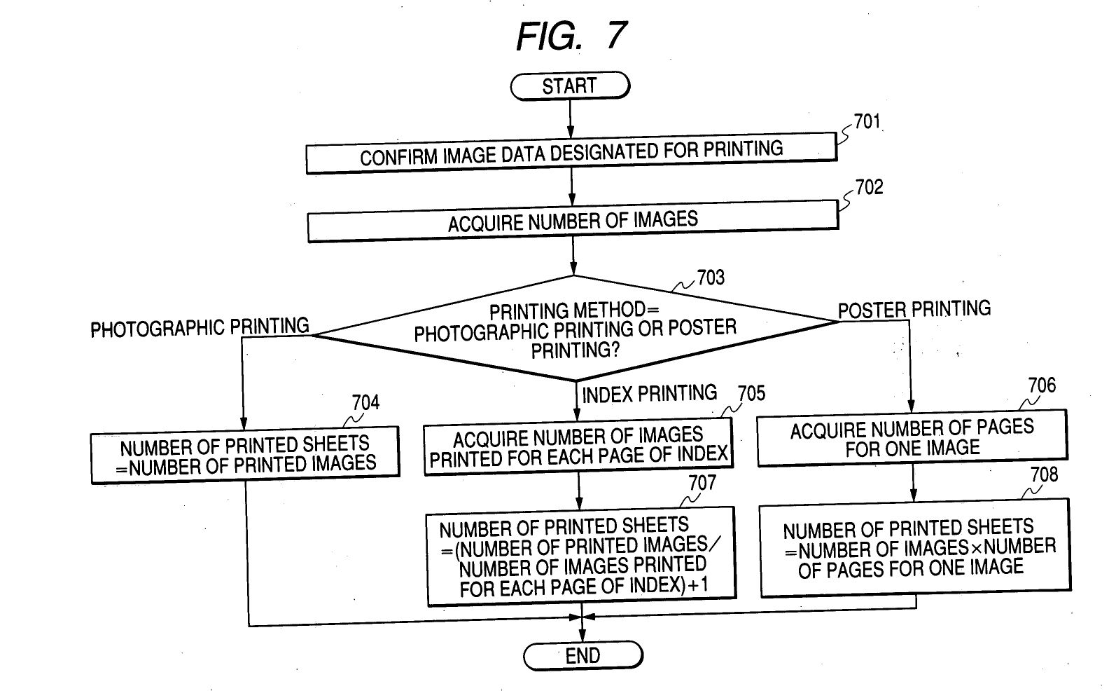

FIG. 7 is a flowchart showing an example for the number-of-printed-sheet-data acquiring means to calculate the number of printed sheets in each of the above embodiment.

First, in step 701, the number of images is confirmed. Image data for an image designated by a user is confirmed through the operation/display unit 108. This image data is the data for an image in a memory card or a memory of an image processing apparatus.

Then, the number of images of the image data confirmed in step 701 is counted in step 702 and a printing method is determined in step 703 when the printing method is photo printing, one image is regarded as one sheet for photo printing in the case of the embodiments 1 to 4.

Therefore, in step 704, the number of printed sheets is regarded as the same number of printed images. Moreover, in step 703, when the printing method is determined as index printing, the information on what number of images will be printed on indexes is acquired in step 705. Then, in step 707, the number of printed sheets is decided. The number of printed indexes is equal to the answer of dividing the printed images by the number of images to be printed on indexes plus 1.

Moreover, when it is determined in step 703 that the printing method is poster printing, what method is the poster printing is acquired. The “poster printing” in this case is a method for printing one image so as to form one image over a plurality of pages. What number of pages is necessary for one image is acquired in step 706 and the number of printed sheets is regarded as the product between printed images and printed pages for one image in step 708.

As described above, the number of sheets to be printed is acquired for a printing request performed by a user.

In the case of the example shown in FIG. 7, the printing method is divided into photo printing, index printing and poster printing. However, as long as it is possible to determine what number of images is used every printing, it is allowed to use another method for printing an image.

According to each of the above embodiments, when the number of printed sheets exceeds the restricted number of printed sheets at the time of printing, it is possible to prompt a user to re-output printing.

According to the present invention, when a user performs a printing designation exceeding the tolerance of an image processing apparatus, it is possible to show the user that the printing designation by the user exceeds the tolerance of the image processing apparatus because printing is confirmed to the user before printing and therefore, an advantage can be obtained that it is possible to prevent unnecessary printing.

This application claims priority from Japanese Patent Application No. 2003-332507 filed Sep. 24, 2003, which is hereby incorporated by reference herein.

1. An image processing apparatus comprising:
printing means for printing photos and characters;
number-of-printed-sheet-data acquiring means for acquiring the number-of-printed-sheet data showing the number of printed sheets before printing is started;
restricted-number-of-printed-sheet-data holding means for holding the restricted-number-of-printed-sheet data showing the restricted number of printed sheets;
operation means for starting or setting printing;
display means for displaying the information on the image processing apparatus; and
display control means for making the display means perform the display for prompting a user to reconfirm start of printing when printing is designated through the operation means and the number of printed sheets shown by the number-of-printed-sheet data acquired by number-of-printed-sheet-data acquiring means exceeds the restricted number of printed sheets.

2. The image processing apparatus according to claim 1, wherein
the number-of-printed-sheet-data acquiring means is means for calculating the number of printed sheets in accordance with the number of images designated by a user by using the operation means when printing the image data and
the display means is means for displaying the number of printed sheets for the user before printing even if the user does not recognize the number of printed sheets.

3. An image processing apparatus comprising:
printing means for printing photos and characters;
number-of-printed-sheet-data acquiring means of acquiring the number-of-printed-sheet data showing the number of printed sheets before printing is started;
restricted-number-of-printed-sheet-data holding means for holding the restricted-number-of-printed-sheet data showing the restricted number of printed sheets;
operation means-for starting or setting printing;
display means for displaying the information on the image processing apparatus;
clocking means for measuring time; and
control means for making the display means perform the display for prompting a user to reconfirm start of printing when the number of printed sheets shown by the number-of-printed-sheet data acquired by the number-of-printed-sheet-data acquiring means exceeds the restricted number of printed sheets, and executing a predetermined operation when a predetermined time passes while the user does not perform the above reconfirmation when printing is designated through the operation means.

4. The image processing apparatus according to claim 3, wherein
the predetermined operation is an operation for starting printing.

5. The image processing apparatus according to claim 3, wherein
the predetermined operation is an operation for not starting printing.

6. An image processing apparatus comprising:
printing means for printing photos and characters;
number-of-printed-sheet-data acquiring means for acquiring the number-of-printed-sheet data showing the number of printed sheets before printing is started;
restricted-number-of-printed-sheet-data holding means for holding the restricted-number-of-printed-sheet data showing the restricted number of printed sheets;
operation means for starting or setting printing;
display means for displaying the information on the image processing apparatus;
clocking means for measuring time; and
control means for not executing printing when the number of printed sheets shown by the number-of-printed-sheet data acquired by the number-of-printed-sheet-data acquiring means exceeds the restricted number of printed sheets when printing is designated through the operation means.

7. The image processing apparatus according to any one of claims 1, 3 and 6, wherein
the display means is means for displaying the total number of printed sheets at the time of reconfirmation of the start of printing.

8. The image processing apparatus according to any one of claims 1, 3 and 6, wherein
the display means is means for displaying that the restricted number of printed sheets is exceeded when the restricted number of printed sheets is exceeded during image printing.

9. The image processing apparatus according to claim 1, wherein
image data storing medium is included which is constituted by a PCMCIA I/F controller and an external storing medium.

10. A control method of an image processing apparatus comprising:
a printing step of printing photos and characters;
a number-of-printed-sheet-data acquiring step of acquiring the number-of-printed-sheet data showing the number of printed sheets before printing is started;
a restricted-number-of-printed-sheet-data holding step of holding the restricted-number-of-printed-sheet data showing the restricted number of printed sheets;
an operation step of starting or setting printing;
a display step of displaying the information on the image processing apparatus on display means; and
a display control step of making the display means perform the display for prompting a user to reconfirm start of printing when printing is designated in the operation step and the number of printed sheets shown by the number-of-printed-sheet data acquired in the number-of-printed-sheet-data acquiring step exceeds the restricted number of printed sheets.

11. A control method of an image processing apparatus comprising:
a printing step of printing photos and characters;
a number-of-printed-sheet-data acquiring step of acquiring the number-of-printed-sheet data showing the number of printed sheets before printing is started;
a restricted-number-of-printed-sheet-data holding step of holding the restricted-number-of-printed-sheet data showing the restricted number of printed sheets;
an operation step of starting or setting printing;
a display step of displaying the information on the image processing apparatus on display means;
a clocking step of measuring time; and
a control step of making the display means perform the display for prompting a user to reconfirm start of printing when printing is designated in the operation step and the number of printed sheets shown by the number-of-printed-sheet data acquired in the number-of-printed-sheet-data acquiring step exceeds the restricted number of printed sheets and executing a predetermined operation when a predetermined time passes while the user does not reconfirm start of printing.

12. A control method of an image processing apparatus comprising:
a printing step of printing photos and characters;
a number-of-printed-sheet-data acquiring step of acquiring the number-of-printed-sheet data showing the number of printed sheets before printing is started;
a restricted-number-of-printed-sheet-data holding step of holding the restricted-number-of-printed-sheet data showing the restricted number of printed sheets;
an operation step of starting or setting printing;
a display step of displaying the information on the image processing apparatus on display means;
a clocking step of measuring time; and
a control step of not executing printing when the number of printed sheets shown by the number-of-printed-sheet data acquired by the number-of-printed-sheet-data acquiring step exceeds the restricted number of printed sheets when printing is designated in the operation step.
